(19) United States
(12) Patent Application Publication
(10) Pub. No.: US 2025/0390468 A1
(43) Pub. Date: Dec. 25, 2025

(54) LOCATING A DATA ITEM IN MULTIPLE DEDUPLICATION STORAGE SYSTEMS

(71) Applicant: Hewlett Packard Enterprise Development LP, Spring, TX (US)

(72) Inventor: Alastair Slater, Chepstow (GB)

(21) Appl. No.: 18/751,571

(22) Filed: Jun. 24, 2024

(51) Int. Cl. G06F 16/174; G06F 16/14; G06F 16/16

(52) U.S. Cl. CPC G06F 16/1752; G06F 16/152; G06F 16/164

(57) ABSTRACT

Example implementations relate to deduplication operations in a storage system. An example implementation includes receiving a target data item to be located in a storage environment, determining deduplication storage systems included in the storage environment, and determining hashing schemes used by the plurality of deduplication storage systems, respectively. The example implementation also includes generating fingerprints by applying, to the target data item, respective hashing schemes of each of the deduplication storage systems. The example implementation further includes identifying potential storage locations of the target data item based on the fingerprints, and generating a location report based on the identified potential storage locations.

### BACKGROUND

Data reduction techniques can be applied to reduce the amount of data stored in a storage system. An example data reduction technique includes data deduplication. Data deduplication identifies data units that are duplicative, and seeks to reduce or eliminate the number of instances of duplicative data units that are stored in the storage system.

### BRIEF DESCRIPTION OF THE DRAWINGS

Some implementations are described with respect to the following figures.

FIGS. 1A-1C are schematic diagrams of example systems, in accordance with some implementations.

FIG. 2 is an illustration of example search operations, in accordance with some implementations.

FIG. 3 is an illustration of an example process, in accordance with some implementations.

FIGS. 4A-4B are illustrations of example operations, in accordance with some implementations.

FIG. 5 is an illustration of an example process, in accordance with some implementations.

FIG. 6 is an illustration of an example operation, in accordance with some implementations.

FIG. 7 is a schematic diagram of an example computing device, in accordance with some implementations.

FIG. 8 is an illustration of an example process, in accordance with some implementations.

FIG. 9 is a diagram of an example machine-readable medium storing instructions in accordance with some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a storage system may back up a collection of data (referred to herein as a “stream” of data or a “data stream”) in deduplicated form, thereby reducing the amount of storage space required to store the data stream. The storage system may create a “backup item” to represent a data stream in a deduplicated form. The storage system may perform a deduplication process including breaking a stream of data into discrete data units (or “chunks”) and determining “fingerprints” (described below) for these incoming data units. Further, the storage system may compare the fingerprints of incoming data units to fingerprints of stored data units, and may thereby determine which incoming data units are duplicates of previously stored data units (e.g., when the comparison indicates matching fingerprints). In the case of data units that are duplicates, the storage system may store references to previously stored data units instead of storing the duplicate incoming data units. A process for receiving and deduplicating an inbound data stream may be referred to herein as a “data ingest” process of a storage system.

In some examples, a storage system may use a particular algorithm or function (referred to herein as a “hashing scheme”) to perform data deduplication. For example, the hashing scheme may include a particular manner of breaking up (or “chunking) a stream of data into discrete data units (e.g., using different block sizes, using a fixed block size, using variable blocks sizes, and so forth). Further, the hashing scheme may include using a particular hash function or algorithm to produce a hash value based on the content of a data unit (e.g., using Secure Hash Algorithm 2 (SHA-2) hash functions, e.g., SHA-224, SHA-256, SHA-384, etc.). In other examples, other types of hashing schemes may be employed. As used herein, the term “fingerprint” refers to a value derived by applying the hash function or algorithm to the content of the data unit (where the “content” can include the entirety or a subset of the content of the data unit).

As used herein, a “storage system” can refer to a storage device or an array of storage devices. A storage system may also include storage controller(s) that manage(s) access of the storage device(s). A “data unit” can refer to any portion of data that can be separately identified in the storage system. In some cases, a data unit can refer to a chunk, a collection of chunks, or any other portion of data. In some examples, a storage system may store data units in persistent storage. Persistent storage can be implemented using one or more of persistent (e.g., nonvolatile) storage device(s), such as disk-based storage device(s) (e.g., hard disk drive(s) (HDDs)), solid state device(s) (SSDs) such as flash storage device(s), or the like, or a combination thereof.

A “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, a “controller” can refer to a combination of a hardware processing circuit and machine-readable instructions (software and/or firmware) executable on the hardware processing circuit.

As used herein, a “storage environment” can refer to a system or service that includes multiple storage systems. The multiple storage systems may implement different hashing schemes for data deduplication. For example, a storage environment may be a datacenter hosting multiple storage systems that perform data deduplication using different block sizes, different block types (e.g., fixed or variable blocks sizes), different hash functions, and so forth.

In some examples, the data owned by a user entity (e.g., a corporation, organization, institution, human user, and so forth) may be stored across multiple storage systems of a storage environment. The user entity may have a need to determine whether a target data item (e.g., a specific file, database, data string, and so forth) is stored in the storage environment, and if so, to determine each storage location of the target data item. For example, the user entity may perform an exhaustive search for the target data item to comply with legal requirements, to satisfy privacy rules, to ensure protection of sensitive data, to ensure data redundancy, and so forth. However, in some examples, performing an exhaustive search process may consume significant amounts of computing and network resources, and may therefore reduce the performance of the storage environment. For example, the search process may involve identifying a set of storage systems included in a storage environment, accessing and mounting the filesystems that are stored in the set of storage systems, and traversing each filesystem to determine each instance and location of the target file.

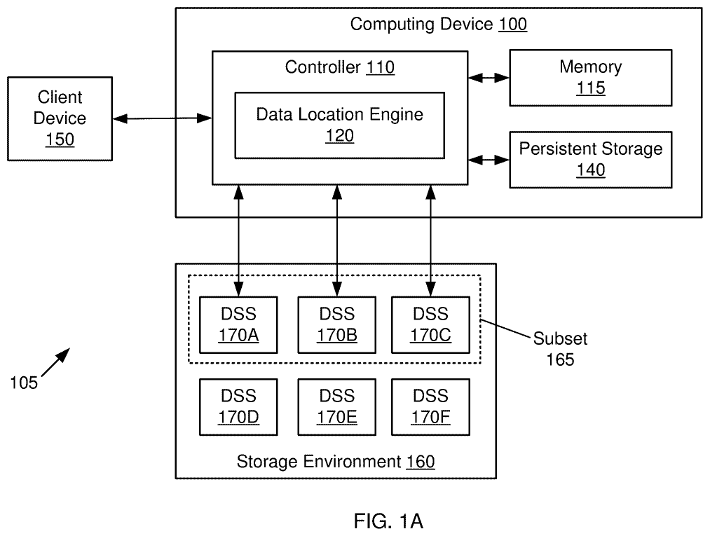

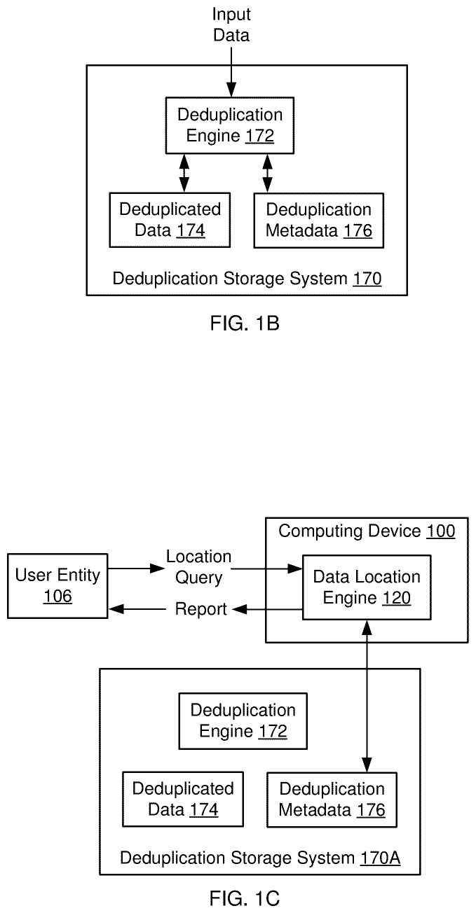

In accordance with some implementations of the present disclosure, a computing device may receive a location request to search for a target data element in a storage environment. The computing device may identify a user entity associated with the location request, and may determine a set of storage systems (included in the storage environment) that are accessible to the user entity. The computing device may then determine the hashing schemes used by the set of storage systems, and may generate multiple fingerprints by applying the determined hashing schemes to the target data item. Further, the computing device may search deduplication metadata of set of storage systems for matches against the generated fingerprints, and may determine the user visible locations (e.g., virtual volumes, databases, etc.) that correspond to any fingerprint matches found in the deduplication metadata. Furthermore, the computing device may generate a summary report that lists each user visible location of the target data item in the set of storage systems. In this manner, the computing device may provide an exhaustive search for the target data item without reducing the performance of the storage environment. The disclosed technique for performing an exhaustive search in a storage environment is discussed further below with reference to FIGS. 1A-9.

### FIGS. 1A-1C—Example System

FIG. 1A shows an example system 105 that includes a computing device 100, a client device 150, and a storage environment 160. The computing device 100, client device 150, and storage environment 160 may be interconnected by data links (e.g., via network links, via a data bus, etc.). Further, some or all of the computing device 100, client device 150, and storage environment 160 may be physical and/or virtual devices, including computing nodes, virtual machines, storage devices, or components thereof.

In some implementations, the computing device 100 may include a controller 110, memory 115, and persistent storage 140. The persistent storage 140 may include one or more non-transitory storage media such as hard disk drives (HDDs), solid state drives (SSDs), optical disks, and so forth, or a combination thereof. The memory 115 may be implemented in semiconductor memory such as random access memory (RAM). In some examples, the controller 110 may be implemented via hardware (e.g., electronic circuitry) or a combination of hardware and programming (e.g., comprising at least one processor and instructions executable by the at least one processor and stored on at least one machine-readable storage medium).

In some implementations, the computing device 100 may execute or include a data location engine 120 (described below). As used herein, an “engine” may refer to machine-readable instructions (e.g., software instructions and/or firmware instructions stored on at least one machine-readable storage medium) executable on a hardware processing circuit. For example, the data location engine 120 may be implemented as program code that is executed by the controller 110 and loaded in memory 115. Further, in some implementations, the program code for the data location engine 120 may be stored in the persistent storage 130. Alternatively, an “engine” may refer to a hardware processing circuit (e.g., any or some combination of a microprocessor, a core of a multi-core microprocessor, a microcontroller, a programmable integrated circuit, a programmable gate array, a digital signal processor, or another hardware processing circuit), or a combination of a hardware processing circuit and machine-readable instructions.

In some implementations, the storage environment 160 may be a system or infrastructure that includes multiple deduplication storage systems 170A-170F (also referred to as “DSSs 170”), which may be referred to herein as a “heterogenous” storage environment 160. In some examples, multiple copies of a data item (or data items) may be stored in multiple DSSs 170. The DSSs 170 may be distinct storage systems or devices that can store data in deduplicated form. The DSSs 170 may use different hashing schemes to perform data deduplication. Each hashing scheme may include a chunking algorithm and/or a hashing function. For example, the DSSs 170 may implement different chunking algorithms to divide input data into data units of various sizes and/or types (e.g., using different block sizes, using fixed or variable blocks sizes, and so forth). Further, the DSSs 170 may use different hash functions to generate the fingerprints for data deduplication. For example, the DSS 170A may generate fingerprints by using a first SHA-2 hash function to full hash values, the DSS 170B may generate fingerprints by using a second SHA-2 hash function to partial hash values, and so forth. Furthermore, in some implementations, the DSSs 170 may store data using different forms of storage topologies or arrangements (e.g., volumes, virtual disks, folders, etc.).

Referring now to FIG. 1B, shown is a block diagram of an example DSS 170 that includes or executes a deduplication engine 172. In some implementations, the deduplication engine 172 may perform deduplication of received input data (e.g., a stream of data units), and may store at least one copy of each data unit as deduplicated data 174. Further, the deduplication engine 172 may use stored deduplication metadata 176 for processing and reconstructing the original input data from the stored deduplicated data 174. Each data unit may be a portion of data that can be separately identified in the storage system 100.

In some implementations, the deduplication engine 172 may use a particular hashing scheme to perform data deduplication. For example, the hashing scheme may include a particular chunking algorithm to divide or “chunk” the input data into discrete data units. Further, the hashing scheme may include using a particular hash function or algorithm to generate a fingerprint based on the content of a data unit (e.g., a full or partial hash value produced by applying a SHA-2 hash function).

In some implementations, to determine whether an input data unit is a duplicate of a stored data unit, the deduplication engine 172 may compare the fingerprint generated for the input data unit to fingerprints stored in the deduplication metadata 176 (e.g., in a container index). The inbound data units with fingerprints that match the stored fingerprints (in deduplication metadata 176) are determined to be copies of previous data units that are already stored in the deduplicated data 174, and the deduplication engine 172 then stores references to the previous data units in the deduplicated data 174 (instead of storing the duplicate input data units). Further, the remaining inbound data units with fingerprints that do not match the stored fingerprints are determined to be new data units (i.e., that are not be included in the deduplicated data 174). The deduplication engine 172 then adds the new data units to the deduplicated data 174, and updates the deduplication metadata 176 to record information about the new data units.

In some implementations, the deduplication metadata 176 may include data representations that record information regarding a collection of stored data units. For example, a data representation of an inbound data stream may record the sequential order in which a set of data units are received in the data stream. The stream representation may include a sequence of data unit references, with each data unit reference representing a particular inbound data unit. Each data unit reference may include a fingerprint to for the referenced data unit. Further, each data unit reference may include a pointer to the storage location of the referenced data unit. Subsequently, in response to a read request, the deduplication system may use a stored data representation to recreate the original data collection.

Referring again to FIG. 1A, in some implementations, the data location engine 120 (in computing device 100) may receive a location query to search for stored instances of a target data item in the storage environment 160. Further, in response to receiving the location query, the data location engine 120 may determine a user entity (e.g., a human user, a company, an organization, an application, etc.) that generated or otherwise caused the location query. For example, the location query may be generated by a user of the client device 105, by a user of the computing device 100, and so forth. The target data item may be a file, data object, string, and so forth.

In some implementations, the data location engine 120 may determine a particular subset 165 of the storage environment 160 (e.g., a particular subset of the DSSs 170) that is accessible to the user entity that generated the location query. For example, the data location engine 120 may identify a particular user entity that initiated the location query, and may determine that the particular user entity can only access (or store data in) the DSSs 170A, 170B, 170C (i.e., in subset 165). In some implementations, the data location engine 120 may execute or perform the location query only in the subset 165 (e.g., by limiting a search for the target data item to the DSSs 170 in subset 165) that is accessible to the particular user entity.

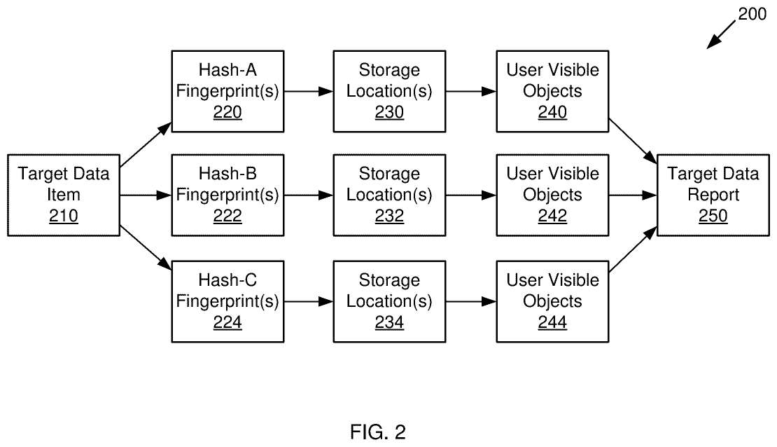

Referring now to FIG. 1C, shown is a block diagram of an example data location engine 120 (in the computing device 100) that receives a location query from a user entity 106. The data location engine 120 determines that the DSS 170A is accessible to the user entity 106, and therefore executes the location query in the DSS 170A. In some implementations, the data location engine 120 may perform a search operation (e.g., to locate the target data item specified in the location query) by directly accessing the deduplication metadata 176 of DSS 170A. For example, the data location engine 120 may generate a fingerprint for the target data item (e.g., using the hashing scheme of DSS 170A), and may attempt to match the generated fingerprint against fingerprints stored in data unit references of the deduplication metadata 176. If a fingerprint match is found in a data unit reference of the deduplication metadata 176, the data location engine 120 may read a pointer included in that data unit reference to determine a storage location of the target data item in the DSS 170A. Further, the data location engine 120 may perform multiple search operations in the subset 165 (i.e., a different search operation in each DSS 170 that is accessible to the user entity). In this manner, the data location engine 120 may execute the location query without accessing or using the deduplication engine 172 (or the deduplicated data 174) in each DSS 170 of the subset 165. An example of the multiple search operations performed by the data location engine is described below with reference to FIG. 2.

### FIG. 2—Example Search Operations

FIG. 2 shows an example illustrating multiple search operations 200 to locate a target data item 210 in the DSSs 170A, 170B, 170C (i.e., subset 165 shown in FIG. 1A) that are accessible to a user entity. In some implementations, the search operations 200 may be performed by the data location engine 120 (shown in FIG. 1A). Further, in the example illustrated in FIG. 2, DSS 170A uses a “Hash-A” hashing scheme, DSS 170B uses a “Hash-B” hashing scheme, and DSS 170C uses a “Hash-C” hashing scheme. In a first stage of the search operations 200, the data location engine 120 may apply these different hashing schemes to the target data item 210 to generate three different sets of fingerprints, namely Hash-A fingerprint(s) 220, Hash-B fingerprint(s) 222, and Hash-C fingerprint(s) 224.

In a second stage of the search operations 200, the data location engine 120 may attempt to match each set of fingerprints against the metadata of a corresponding DSS 170, and thereby determine the storage locations (if any) of a target data item 210 in that DSS 170. For example, the data location engine 120 may match the Hash-A fingerprint(s) 220 against the deduplication metadata 176 of DSS 170A, and may use any matches to determine the storage location(s) 230 of the target data item 210 in DSS 170A. Further, the data location engine 120 may match the Hash-B fingerprint(s) 222 against the deduplication metadata 176 of DSS 170B, and may use any matches to determine the storage location(s) 232 of the target data item 210 in DSS 170B. Similarly, the data location engine 120 may match the Hash-C fingerprint(s) 224 against the deduplication metadata 176 of DSS 170C, and may use any matches to determine the storage location(s) 234 of the target data item 210 in DSS 170C.

In a third stage of the search operations 200, the data location engine 120 may translate the storage location(s) 230 into the user visible objects 240. For example, the data location engine 120 may access metadata that indicates the storage topology or arrangement used by the DSS 170A, and may use the metadata to map the storage location(s) 230 into user visible objects 240 (e.g., volumes, virtual disks, or databases that are visible and/or accessible to the user entity). Similarly, the data location engine 120 may translate the storage location(s) 232 into the user visible objects 242, and may translate the storage location(s) 234 into the user visible objects 244.

In a fourth stage of the search operations 200, the data location engine 120 may generate a target data report 250 that summarizes or lists the user visible objects 240, 242, 244 that store the target data item 210. In some implementations, the target data report 250 may be communicated or returned to the user entity that submitted the location query for the target data item 210.

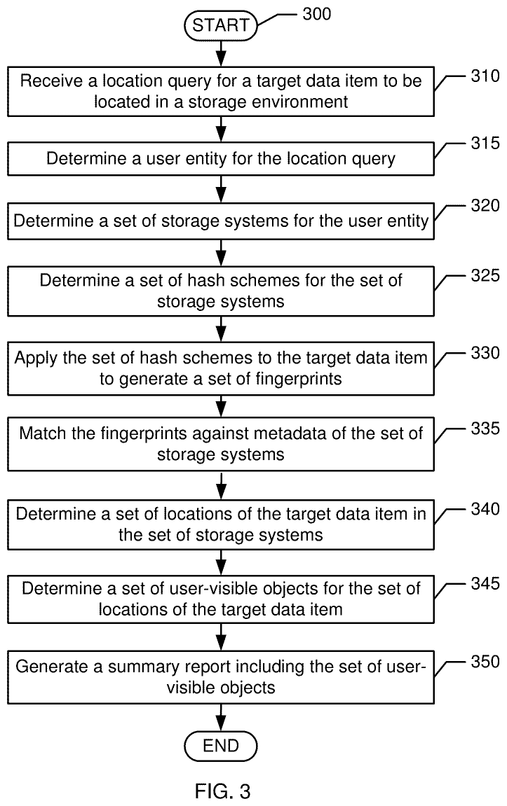

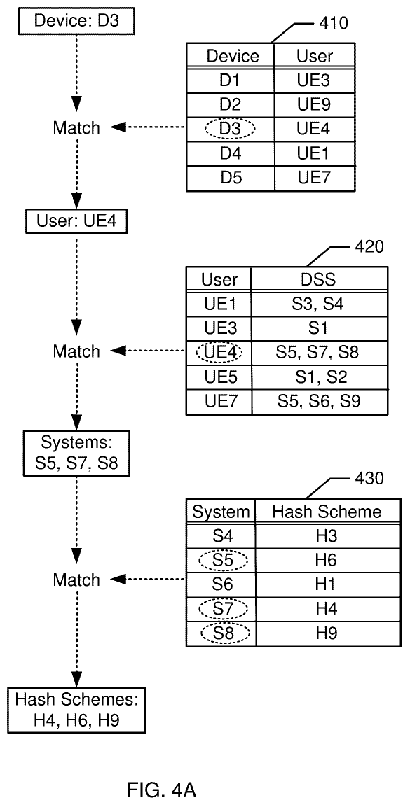

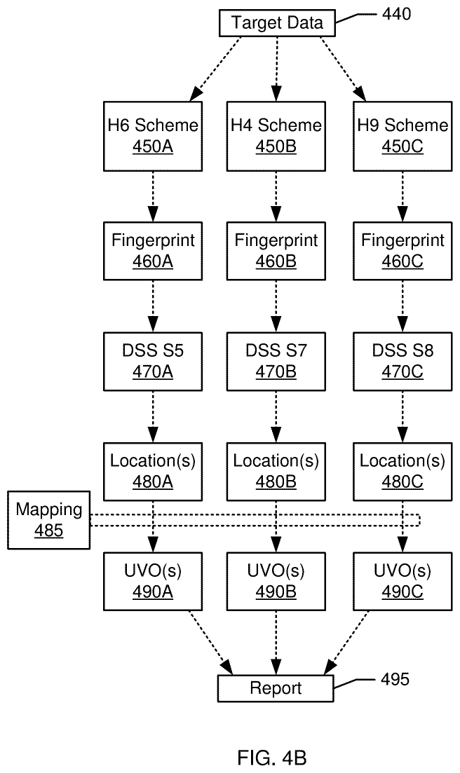

### FIGS. 3-4B—Example Process for Locating a Data Item

FIG. 3 shows an example process 300 for locating a data item, in accordance with some implementations. For the sake of illustration, details of the process 300 may be described below with reference to FIGS. 1A-2 and 4A-4B, which show examples in accordance with some implementations. However, other implementations are also possible. In some examples, the process 300 may be performed using the controller 110 (shown in FIG. 1A). The process 300 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Referring to FIG. 3, block 310 may include receiving a location query for a target data item to be located in a storage environment. For example, referring to FIG. 1A, the data location engine 120 (e.g., executed by controller 110) receives a location query from a client device 150. In some implementations, all or part of the location query may include (or identify) a target data item to be located in a storage environment 160 that includes multiple deduplication storage systems (DSSs) 170A-170F. The DSSs 170A-170F may use different hashing schemes to perform data deduplication.

Referring again to FIG. 3, block 315 may include determining a user entity for the location query. For example, referring to FIG. 4A, a controller (e.g., executing the data location engine 120 shown in FIG. 1A) determines that the location query was received from a user device “D3,” and uses a stored data structure 410 to determine that the user device “D3” is associated with the user entity “UE4.” The stored data structure 410 (e.g., table, database, etc.) may list different computing devices, and may also list the user entity that uses or owns each computing device.

Referring again to FIG. 3, block 320 may include determining a set of storage systems for the user entity. For example, referring to FIG. 4A, the controller uses a stored data structure 420 to determine that the user entity “UE4” has access or permission to a set of three DSSs (“S5, S7, S8”). The stored data structure 420 may list different user entities, and may also list the DSSs that are accessible to each user entity.

Referring again to FIG. 3, block 325 may include determining a set of hash schemes for the set of storage systems. For example, referring to FIG. 4A, the controller uses a stored data structure 430 to determine that the DSSs “S5,” “S7,” “S8” respectively use the hashing schemes “H6,” “H4,” “H9.” The stored data structure 430 may list different DSSs, and may also list or identify the hashing schemes used by the DSSs.

Referring again to FIG. 3, block 330 may include applying the set of hash schemes to the target data item to generate a set of fingerprints. For example, referring to FIG. 4B, the controller applies the “H6” hashing scheme 450A to the target data item 440, thereby generating the fingerprint 460A. Further, the controller applies the “H4” hashing scheme 450B to the target data item 440, thereby generating the fingerprint 460B. Furthermore, the controller applies the “H9” hashing scheme 450C to the target data item 440, thereby generating the fingerprint 460C.

Referring again to FIG. 3, block 335 may include matching the fingerprints against metadata of the set of storage systems. Block 340 may include determining a set of locations of the target data item in the set of storage systems. For example, referring to FIG. 4B, the controller attempts to match the fingerprint 460A against fingerprints stored in data unit references of the deduplication metadata of DSS “S5” 470A. If a fingerprint match is found in a data unit reference of the deduplication metadata, the controller may read a pointer included in that data unit reference to determine storage location(s) 480A of the target data item 440 in DSS “S5” 470A. Further, the controller matches the fingerprint 460B against deduplication metadata of DSS “S7” 470B, and thereby determines storage location(s) 480B of the target data item 440 in DSS “S7” 470B. Furthermore, the controller matches the fingerprint 460C against deduplication metadata of DSS “S8” 470C, and thereby determines storage location(s) 480C of the target data item 440 in DSS “S8” 470C.

Referring again to FIG. 3, block 345 may include determining a set of user-visible objects for the set of locations of the target data item. For example, referring to FIG. 4B, the controller uses a mapping data structure 485 to translates the storage location(s) 480A into one or more user visible objects (UVOs) 490A in the DSS “S5” 470A. The mapping data structure 485 may map or translate storage locations into UVOs (e.g., volumes, virtual disks, databases, and so forth) that are accessible by (or visible to) the user entity that generated the location query. Further, the controller uses the mapping data structure 485 to translate the storage location(s) 480B into UVO(s) 490B in the DSS “S7” 470B, and to translate the storage location(s) 480C into UVO(s) 490C in the DSS “S8” 470C.

Referring again to FIG. 3, block 350 may include generating a summary report including the set of user-visible objects. For example, referring to FIG. 4B, the controller generates a report 495 that summarizes or lists the UVOs 490A, 490B, 490C (in the DSSs 470A, 470B, 470C) that store the target data item 440. In some implementations, the report 495 may be communicated or returned to the user entity that submitted the location query for the target data item 440. In this manner, the controller may provide an exhaustive search for the target data item 440 without reducing the performance of the DSSs 470A, 470B, 470C.

Note that, while FIGS. 4A-4B shows various example data structures 410, 420, 430, 485, implementations are not limited in this regard. For example, it is contemplated that the data structure 410 may include different and/or additional identification information (e.g., network addresses, user names, group identifiers, digital signatures, and so forth). In another example, it is contemplated that the data structures 410, 420, 430, 485 may be combined into fewer (or a single) data structure. Other combinations and/or variations are also possible.

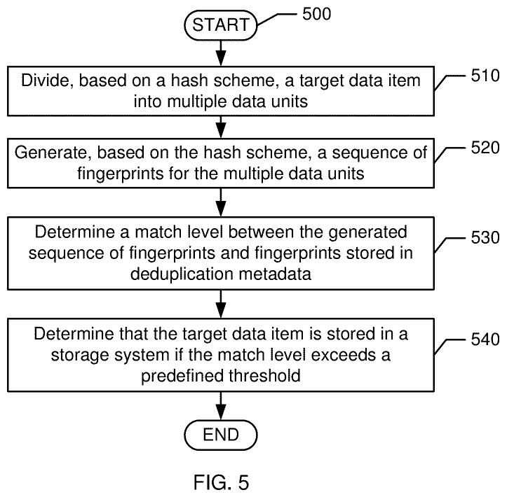

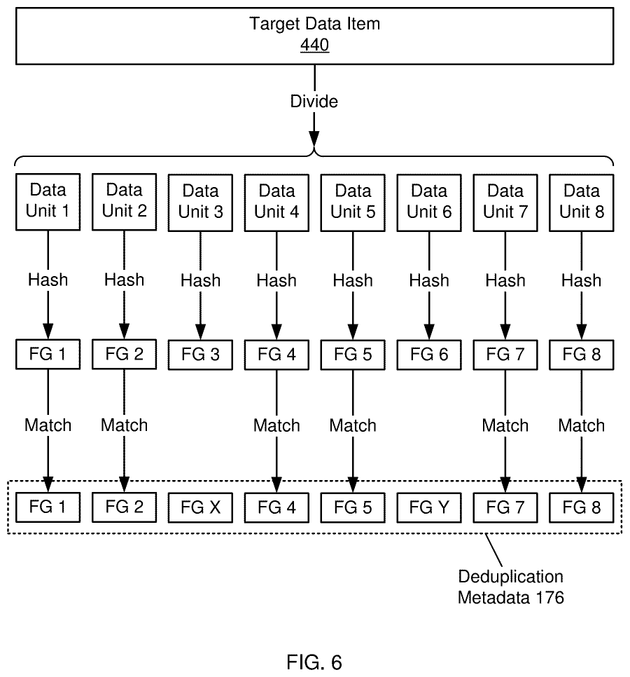

### FIGS. 5-6—Example Process

FIG. 5 shows an example process 500, in accordance with some implementations. The process 500 may correspond generally to an example implementation of blocks 330 and 335 (discussed above with reference to FIG. 3).

For the sake of illustration, details of the process 500 may be described below with reference to FIGS. 1A-4B and 6, which show examples in accordance with some implementations. However, other implementations are also possible. In some examples, the process 500 may be performed using the controller 110 (shown in FIG. 1A). The process 500 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Referring to FIG. 5, block 510 may include dividing, based on a hash scheme, a target data item into multiple data units. Block 520 may include generating, based on the hash scheme, a sequence of fingerprints for the multiple data units. For example, referring to FIG. 6, a controller (e.g., executing the data location engine 120 shown in FIG. 1A) divides a target data item 440 into a sequence of data units 1-8 according to a hashing scheme (e.g., the “H6” hashing scheme 450A shown in FIG. 4B). Further, the controller applies a hashing function (e.g., based on the hashing scheme) to the sequence of data units 1-8, thereby generating a sequence of fingerprints (FGs) 1-8.

Referring again to FIG. 5, block 530 may include determining a match level between the generated sequence of fingerprints and fingerprints stored in deduplication metadata. For example, referring to FIG. 6, the controller compares the generated sequence of fingerprints 1-8 to stored fingerprints in the deduplication metadata 176), and calculates the match levels between the generated sequence of fingerprints 1-8 and various sequences of the stored fingerprints. As used herein, a “match level” may be a measure of the similarity between two ordered sets of fingerprints. In some implementations, the match level may be the proportion or quantity of fingerprints that are present in both sets being compared, and that are arranged in the same sequential order. For example, as shown in FIG. 6, six fingerprints (“FG 1,” “FG 2,” “FG 4,” “FG 5,” “FG 7,” (FG 8″) are matched in both the generated fingerprints and the deduplication metadata 176, and are arranged in the same order relative to each other. Accordingly, the match level may be a total number of 6 matches, a percentage of 66.7% (i.e., 6 out of 8), and so forth. However, other implementations are possible. For example, the match level may be calculated as the total number of matching fingerprints that are found in any order within a particular portion (e.g., a set of adjacent data unit references) of the deduplication metadata 176. In another example, the match level may be calculated by applying a first weight to each matching fingerprint, and applying a second weight to each instance of matching fingerprints that occur in the same sequential order. Other variations are possible.

Referring again to FIG. 5, block 540 may include determining that the target data item is stored in a storage system if the match level exceeds a predefined threshold. For example, referring to FIG. 6, the controller determines that the match levels between the generated sequence of fingerprints 1-8 and a sequence of stored fingerprints in a metadata portion exceeds a predefined threshold (e.g., five matching fingerprints, 60% match, and so forth). In response to this positive determination, the controller determines that the metadata portion (including the matching sequence of stored fingerprints) represents a storage location of the target data item 440. Accordingly, that storage location may be used to generate an entry in a location report, as described above with reference to FIG. 3. Further, in some implementations, the entry in the location report may include the match level (or a value or indication based on the match value) that was calculated to identify the storage location. For example, the match level may indicate a degree of confidence or probability that the storage location (or the corresponding user visible object) actually stores the target data item 440. In this manner, including the match levels in the location report may provide useful information to the user entity.

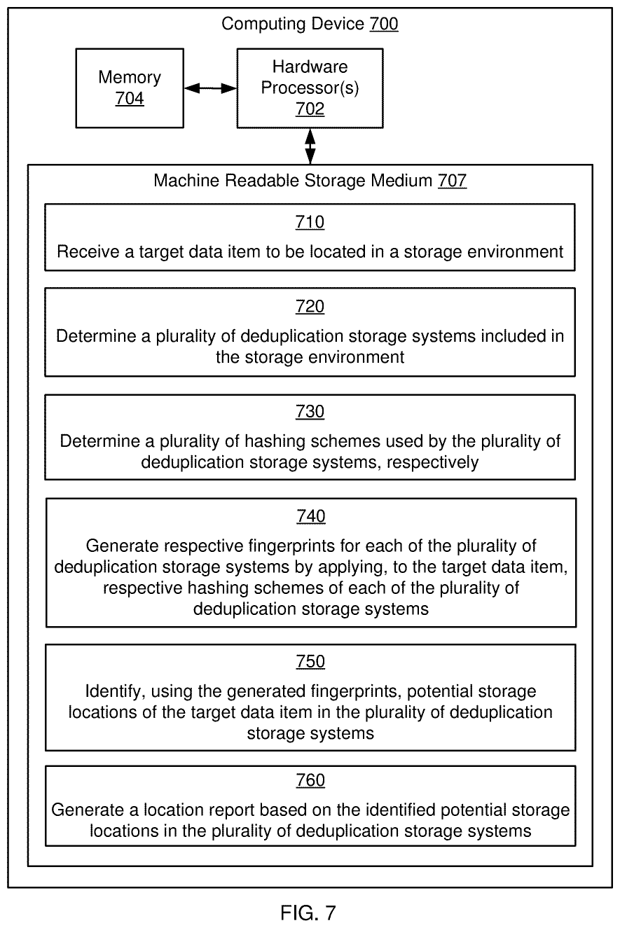

### FIG. 7—Example Computing Device

FIG. 7 shows a schematic diagram of an example computing device 700. In some examples, the computing device 700 may correspond generally to some or all of the computing device 100 (shown in FIG. 1A). As shown, the computing device 700 may include a hardware processor 702, a memory 704, and machine-readable storage 705 including instructions 710-750. The machine-readable storage 705 may be a non-transitory medium. The instructions 710-750 may be executed by the hardware processor 702, or by a processing engine included in hardware processor 702.

Instruction 710 may be executed to receive a target data item to be located in a storage environment. For example, referring to FIG. 1A, the data location engine 120 (e.g., executed by controller 110) receives a location query that includes a target data item to be located in a storage environment 160 that includes multiple deduplication storage systems (DSSs) 170A-170F. The DSSs 170A-170F use different hashing schemes to perform data deduplication.

Referring again to FIG. 7, instruction 720 may be executed to determine a plurality of deduplication storage systems included in the storage environment. For example, referring to FIG. 4A, a controller (e.g., executing the data location engine 120 shown in FIG. 1A) determines that the location query was received from a user device “D3,” and uses a stored data structure 410 to determine that the user device “D3” is associated with the user entity “UE4.” Further, the controller uses a stored data structure 420 to determine that the user entity “UE4” has access or permission to a set of three DSSs (“S5, S7, S8”).

Referring again to FIG. 7, instruction 730 may be executed to determine a plurality of hashing schemes used by the plurality of deduplication storage systems, respectively. For example, referring to FIG. 4A, the controller uses a stored data structure 430 to determine that the DSSs “S5,” “S7,” “S8” respectively use the hashing schemes “H6,” “H4,” “H9.”

Referring again to FIG. 7, instruction 740 may be executed to generate respective fingerprints for each of the plurality of deduplication storage systems by applying, to the target data item, respective hashing schemes of each of the plurality of deduplication storage systems. For example, referring to FIG. 4B, the controller applies the “H6” hashing scheme 450A to the target data item 440, thereby generating the fingerprint 460A. Further, the controller applies the “H4” hashing scheme 450B to the target data item 440, thereby generating the fingerprint 460B. Furthermore, the controller applies the “H9” hashing scheme 450C to the target data item 440, thereby generating the fingerprint 460C.

Referring again to FIG. 7, instruction 750 may be executed to identify, using the generated fingerprints, potential storage locations of the target data item in the plurality of deduplication storage systems. For example, referring to FIG. 4B, the controller attempts to match the fingerprint 460A against fingerprints stored in data unit references of the deduplication metadata of DSS “S5” 470A. If a fingerprint match is found in a data unit reference of the deduplication metadata, the controller may read a pointer included in that data unit reference to determine storage location(s) 480A of the target data item 440 in DSS “S5” 470A. Further, the controller matches the fingerprint 460B against deduplication metadata of DSS “S7” 470B, and thereby determine storage location(s) 480B of the target data item 440 in DSS “S7” 470B. Furthermore, the controller matches the fingerprint 460C against deduplication metadata of DSS “S8” 470C, and thereby determine storage location(s) 480C of the target data item 440 in DSS “S8” 470C.

Referring again to FIG. 7, instruction 760 may be executed to generate a location report based on the identified potential storage locations in the plurality of deduplication storage systems. For example, referring to FIG. 4B, the controller uses a mapping data structure 485 to translates the storage location(s) 480A into one or more user visible objects (UVOs) 490A in the DSS “S5” 470A. Further, the controller uses the mapping data structure 485 to translate the storage location(s) 480B into UVO(s) 490B in the DSS “S7” 470B, and to translate the storage location(s) 480C into UVO(s) 490C in the DSS “S8” 470C. Furthermore, the controller generates a report 495 that summarizes or lists the UVOs 490A, 490B, 490C (in the DSSs 470A, 470B, 470C) that store the target data item 440. In some implementations, the report 495 may be communicated or returned to the user entity that submitted the location query for the target data item 440.

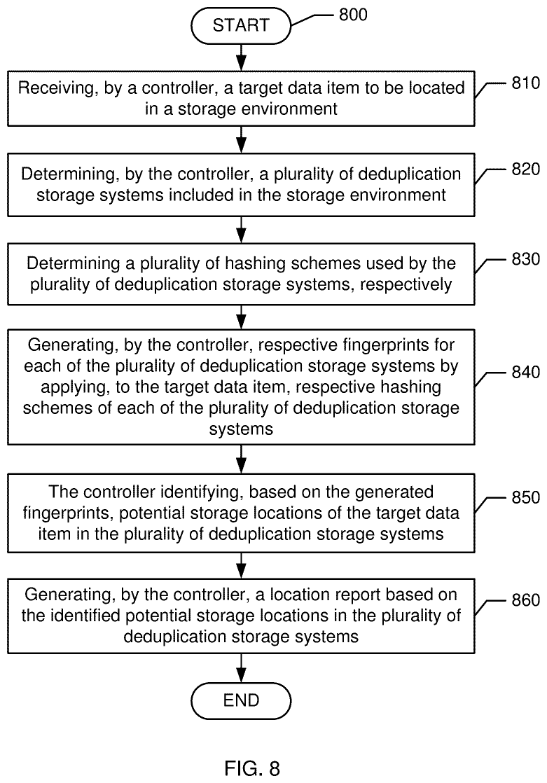

### FIG. 8—Example Process for Locating a Data Item

FIG. 8 shows an example process 800 for locating a data item, in accordance with some implementations. In some examples, the process 800 may be performed using the controller 110 (shown in FIG. 1). The process 800 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 810 may include receiving, by a controller, a target data item to be located in a storage environment. Block 820 may include determining, by the controller, a plurality of deduplication storage systems included in the storage environment.

Block 830 may include determining a plurality of hashing schemes used by the plurality of deduplication storage systems, respectively. Block 840 may include generating, by the controller, respective fingerprints for each of the plurality of deduplication storage systems by applying, to the target data item, respective hashing schemes of each of the plurality of deduplication storage systems.

Block 850 may include the controller identifying, based on the generated fingerprints, potential storage locations of the target data item in the plurality of deduplication storage systems. Block 860 may include generating, by the controller, a location report based on the identified potential storage locations in the plurality of deduplication storage systems. Blocks 810-860 may correspond generally to the examples described above with reference to instructions 710-760 (shown in FIG. 7).

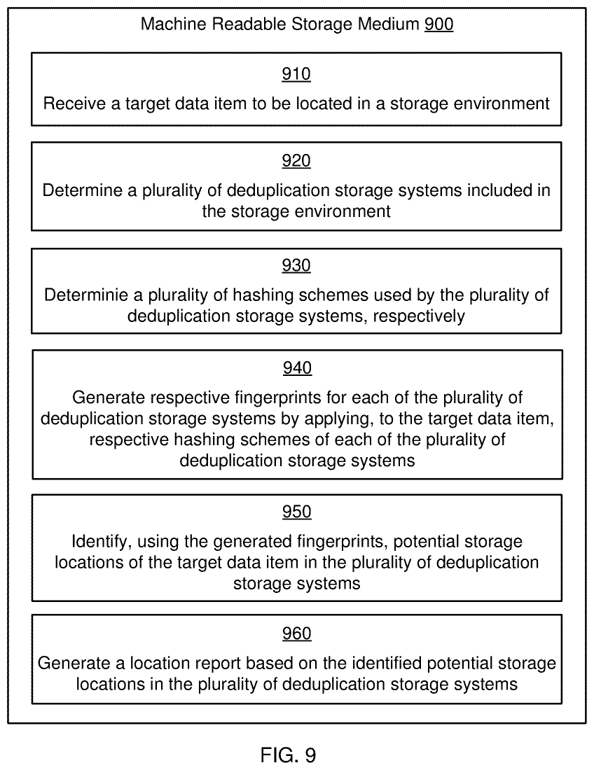

### FIG. 9—Example Machine-Readable Medium

FIG. 9 shows a machine-readable medium 900 storing instructions 910-960, in accordance with some implementations. The instructions 910-960 can be executed by a single processor, multiple processors, a single processing engine, multiple processing engines, and so forth. The machine-readable medium 900 may be a non-transitory storage medium, such as an optical, semiconductor, or magnetic storage medium. The instructions 910-960 may correspond generally to the examples described above with reference to instructions 710-760 (shown in FIG. 7).

Instruction 910 may be executed to receive a target data item to be located in a storage environment. Instruction 920 may be executed to determine a plurality of deduplication storage systems included in the storage environment.

Instruction 930 may be executed to identify a plurality of hashing schemes used by the plurality of deduplication storage systems, respectively. Instruction 940 may be executed to generate respective fingerprints for each of the plurality of deduplication storage systems by applying, to the target data item, respective hashing schemes of each of the plurality of deduplication storage systems.

Instruction 950 may be executed to determine, using the generated fingerprints, potential storage locations of the target data item in the plurality of deduplication storage systems. Instruction 960 may be executed to generate a location report based on the identified potential storage locations in the plurality of deduplication storage systems.

### Conclusion

In accordance with implementations described herein, a computing device may receive a target data element being searched for in a storage environment. The computing device may identify a user entity associated with the target data item, and may determine a set of storage systems (included in the storage environment) that are accessible to the user entity. The computing device may then determine the hashing schemes used by the set of storage systems, and may generate multiple fingerprints by applying the determined hashing schemes to the target data item. Further, the computing device may search deduplication metadata of set of storage systems for matches against the generated fingerprints, and may determine the user visible locations (e.g., virtual volumes, databases, etc.) that correspond to any fingerprint matches found in the deduplication metadata. Furthermore, the computing device may generate a summary report that lists each user visible location of the target data item in the set of storage systems. In this manner, the computing device may provide an exhaustive search for the target data item without reducing the performance of the storage environment.

Note that, while FIGS. 1A-9 show various examples, implementations are not limited in this regard. For example, referring to FIG. 1A, it is contemplated that the computing device 100 may include additional devices and/or components, fewer components, different components, different arrangements, and so forth. In another example, it is contemplated that the storage environment 160 may include any number and/or type of DSSs 170. Further, it is contemplated that the functionality of the controller 110 described above may be included in any another engine or software of the computing device 100, of an external device, of a network service, and so forth. Other combinations and/or variations are also possible.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is(are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A computing device comprising:
a processor;
a memory; and
a machine-readable storage storing instructions, the instructions executable by the processor to:
receive a location query for a target data item to be located in a storage environment including a set of deduplication storage systems that use different hashing schemes;
determine a plurality of deduplication storage systems based on the received location query, wherein the plurality of deduplication storage systems is a subset of the set of deduplication storage systems included in the storage environment;
determine a plurality of hashing schemes used by the plurality of deduplication storage systems, respectively;
generate a plurality of fingerprints that represent the target data item, wherein each of plurality of fingerprints is generated by applying, to the target data item, a different hashing scheme of the plurality of hashing schemes used by the plurality of deduplication storage systems;
identify, using the generated plurality of fingerprints that represent the target data item, potential storage locations of the target data item in the plurality of deduplication storage systems; and
generate a location report based on the identified potential storage locations in the plurality of deduplication storage systems.

2. The computing device of claim 1, including instructions executable by the processor to:
determine a particular user entity associated with the location query; and
determine the plurality of deduplication storage systems to include each deduplication storage system that is accessible to the particular user entity.

3. The computing device of claim 2, including instructions executable by the processor to, for each deduplication storage system of the plurality of deduplication storage systems:
identify a set of fingerprint matches between the generated plurality of fingerprints and fingerprints stored in a set of metadata records of the deduplication storage system; and
identify the potential storage locations of the target data item based on the set of metadata records of the deduplication storage system.

4. The computing device of claim 3, including instructions executable by the processor to, for each deduplication storage system of the plurality of deduplication storage systems:
translate, based on a mapping data structure, the potential storage locations into user visible objects; and
generate the location report comprising a listing of the user visible objects.

5. The computing device of claim 4, wherein the location report further comprises a degree of confidence associated with each user visible object including in the location report.

6. The computing device of claim 2, including instructions executable by the processor to:
identify a source device that generated the location query; and
determine, based on the identified source device, the particular user entity associated with the location query.

7. The computing device of claim 1, wherein each of the plurality of hashing schemes includes a chunking algorithm and a hashing function.

8. The computing device of claim 1, including instructions executable by the processor to, for each deduplication storage system of the plurality of deduplication storage systems:
divide, based on the respective hashing scheme of the deduplication storage system, the target data item into a set of data units;
generate, based on the respective hashing scheme of the deduplication storage system, a sequence of fingerprints for the set of data units;
determine a match level between the generated sequence of fingerprints and a sequence of stored fingerprints of the deduplication storage system; and
determine that the target data item is stored in the deduplication storage system in response to a determination that the match level exceeds a predefined threshold.

9. A method comprising:
receiving, by a processor, a location query for a target data item to be located in a storage environment including a set of deduplication storage systems that use different hashing schemes;
determining, by the processor, a plurality of deduplication storage systems based on the received location query, wherein the plurality of deduplication storage systems is a subset of the set of deduplication storage systems included in the storage environment;
determining, by the processor, a plurality of hashing schemes used by the plurality of deduplication storage systems, respectively;
generating, by the processor, a plurality of fingerprints that represent the target data item, wherein each of plurality of fingerprints is generated by applying, to the target data item, a different hashing scheme of the plurality of hashing schemes used by the plurality of deduplication storage systems;
the processor identifying, based on the generated plurality of fingerprints that represent the target data item, potential storage locations of the target data item in the plurality of deduplication storage systems; and
generating, by the processor, a location report based on the identified potential storage locations in the plurality of deduplication storage systems.

10. The method of claim 9, further comprising:
determining a particular user entity associated with the location query; and
determining the plurality of deduplication storage systems to include each deduplication storage system that is accessible to the particular user entity.

11. The method of claim 10, further comprising, for each deduplication storage system of the plurality of deduplication storage systems:
identifying a set of fingerprint matches between the generated plurality of fingerprints and fingerprints stored in a set of metadata records of the deduplication storage system; and
identifying the potential storage locations of the target data item based on the set of metadata records of the deduplication storage system.

12. The method of claim 11, further comprising, for each deduplication storage system of the plurality of deduplication storage systems:
translating, based on a mapping data structure, the potential storage locations into user visible objects; and
generating the location report comprising a listing of the user visible objects.

13. The method of claim 10, further comprising:
identifying a source device that generated the location query; and
determining, based on the identified source device, the particular user entity associated with the location query.

14. The method of claim 9, further comprising, for each deduplication storage system of the plurality of deduplication storage systems:
dividing, based on the respective hashing scheme of the deduplication storage system, the target data item into a set of data units;
generating, based on the respective hashing scheme of the deduplication storage system, a sequence of fingerprints for the set of data units;
determining a match level between the generated sequence of fingerprints and a sequence of stored fingerprints of the deduplication storage system; and
determining that the target data item is stored in the deduplication storage system in response to a determination that the match level exceeds a predefined threshold.

15. A non-transitory machine-readable medium storing instructions that upon execution cause a processor to:
receive a location query for a target data item to be located in a storage environment including a set of deduplication storage systems that use different hashing schemes;
determine a plurality of deduplication storage systems based on the received location query, wherein the plurality of deduplication storage systems is a subset of the set of deduplication storage systems included in the storage environment;
determine a plurality of hashing schemes used by the plurality of deduplication storage systems, respectively;
generate a plurality of fingerprints that represent the target data item, wherein each of plurality of fingerprints is generated by applying, to the target data item, a different hashing scheme of the plurality of hashing schemes used by the plurality of deduplication storage systems;
identify, using the generated plurality of fingerprints that represent the target data item, potential storage locations of the target data item in the plurality of deduplication storage systems; and
generate a location report based on the identified potential storage locations in the plurality of deduplication storage systems.

16. The non-transitory machine-readable medium of claim 15, including instructions executable by the processor to:
determine a particular user entity associated with the location query; and
determine the plurality of deduplication storage systems to include each deduplication storage system that is accessible to the particular user entity.

17. The non-transitory machine-readable medium of claim 16, including instructions executable by the processor to, for each deduplication storage system of the plurality of deduplication storage systems:
identify a set of fingerprint matches between the generated plurality of fingerprints and fingerprints stored in a set of metadata records of the deduplication storage system; and
identify the potential storage locations of the target data item based on the set of metadata records of the deduplication storage system.

18. The non-transitory machine-readable medium of claim 17, including instructions executable by the processor to, for each deduplication storage system of the plurality of deduplication storage systems:
translate, based on a mapping data structure, the potential storage locations into user visible objects; and
generate the location report comprising a listing of the user visible objects.

19. The non-transitory machine-readable medium of claim 16, including instructions executable by the processor to:
identify a source device that generated the location query; and
determine, based on the identified source device, the particular user entity associated with the location query.

20. The non-transitory machine-readable medium of claim 15, including instructions executable by the processor to, for each deduplication storage system of the plurality of deduplication storage systems:
divide, based on the respective hashing scheme of the deduplication storage system, the target data item into a set of data units;
generate, based on the respective hashing scheme of the deduplication storage system, a sequence of fingerprints for the set of data units;
determine a match level between the generated sequence of fingerprints and a sequence of stored fingerprints of the deduplication storage system; and
determine that the target data item is stored in the deduplication storage system in response to a determination that the match level exceeds a predefined threshold.
